(19) United States
(12) Patent Application Publication
(10) Pub. No.: US 2025/0047406 A1
(43) Pub. Date: Feb. 6, 2025

(54) OPTICAL NETWORK UNIT, CENTRAL OFFICE NODE AND METHODS OF CONFIGURING AN OPTICAL NETWORK UNIT

(71) Applicant: Telefonaktiebolaget LM Ericsson (PUBL), Stockholm (SE)

(72) Inventors: Paola IOVANNA, Pisa (PI) (IT); Luca GIORGI, Pisa (PI) (IT)

(21) Appl. No.: 18/718,168

(22) PCT Filed: Dec. 22, 2021
(86) PCT No.: PCT/EP2021/087280

§ 371 Date: Jun. 10, 2024

(51) Int. Cl. H04J 14/02

(52) U.S. Cl. CPC H04J 14/0275; H04J 14/0246; H04J 14/025; H04J 14/0282

(57) ABSTRACT

An optical network unit, ONU, (100) for a passive optical network, PON, comprising:
a tunable receiver (110);
a tunable transmitter (120); and
a controller (130, 230) comprising a processor (132) and memory (134) containing instructions (136) executable by the processor whereby the ONU is operative to:
   if the tunable transmitter is on, switch the tunable transmitter off and if the tunable receiver is off, switch the tunable receiver on;
   determine a downstream control channel wavelength;
   set an operating wavelength of the tunable receiver to the downstream control channel wavelength;
   receive a downstream control channel signal at the downstream control channel wavelength from a central office, CO, node of the PON, the downstream control channel signal carrying an indication of an allocation of channel wavelengths to ONUs;
   obtain allocated downstream and upstream channel wavelengths for the ONU from the indication of an allocation of channel wavelengths to ONUs;
   set an operating wavelength of the tunable receiver to the allocated downstream channel wavelength and set the operating wavelength of the tunable transmitter to the allocated upstream channel wavelength; and
   switch the tunable transmitter on.

### TECHNICAL FIELD

The invention relates to an optical network unit, ONU, for a passive optical network, PON and a central office, CO, node for a PON. The invention further relates to a method of configuring an ONU of a PON and a method of controlling operating wavelengths of an ONU of a passive optical network, PON.

### BACKGROUND

Using installed PONs for other purposes, for example mobile fronthaul and backhaul, enables reuse of existing infrastructure to carry new services, saving the cost of new installations. Another advantage of using a PON for mobile transport purposes is its bidirectional operation; a PON uses a single fiber for both upstream, US, and downstream, DS propagation directions. This simplifies installation procedures, since it is not necessary to take care identifying which fiber is used for DS and which for US.

Mobile transport over PON is addressed in the ITU-T Supplement G.Sup66, which considers two scenarios: 1) a hybrid scenario with fixed access services running over a legacy time division multiplexed, TDM, PON, plus a wavelength division multiplexing, WDM, overlay reserved to wireless services; and 2) a TDM PON fully dedicated to wireless services. In the first scenario, point to point wavelengths, different from the US and DS wavelengths of the legacy PON, are used for wireless services. A coexistence filter couples the legacy PON optical line terminations, OLTs, to the WDM systems used for wireless services. In the second scenario, dedicated wavelengths are used for latency demanding services or time-sensitive fronthaul interfaces (for example, those using the common public radio interface, CPRI, or the enhanced CPRI, eCPRI), while other services are managed using Dynamic Bandwidth Allocation, DBA, algorithms. However, conventional DBAs introduce several milliseconds of delay and significant packet delay variation, which is not compatible with most of the new real-time services enabled by 5G.

To reduce the number of equipment variants due to the high number of wavelengths in a PON, the use of full-tunable Optical Network Terminations, ONT, (also known as optical network units, ONUs) is required. A full-tunable ONT is able to transmit and receive at every wavelength of the wavelengths plan of the PON. Many operators require the use of existing deployed PON infrastructure as it is, without installing wavelength selective devices at the distribution node, but just using the installed wavelength agnostic distribution node that comprises a power splitter. This requires the presence of an optical tunable filter at the receiver side of the full-tunable ONT, in addition to a tunable laser at the transmitter side, as regularly implemented in commercial transceivers. According to ITU-T Supplement G.Sup66, the use of full tunable WDM transceivers is recommended at the ONT and optional, though desirable, at the OLT, where traditional fixed-wavelengths pluggable transceivers and wavelength multiplexers and demultiplexers can alternatively be used.

An issue with WDM systems is their high number of wavelengths, which requires the provision of a high number of spare parts (one per wavelength) and the labelling of each ONT port with the corresponding wavelength. This increases the complexity and cost of the network operation and maintenance processes. Moreover, the PON optical distribution node, ODN, is based on power splitters that don't have the capability to select the wavelength. Hence, wavelength demultiplexers or wavelength selective optical filters must be cascaded to the ODN splitter or embedded in the ONU, respectively. A full tunable WDM Transceiver, TRX, i.e. a transceiver including a tunable laser at the transmitter and a tunable optical filter at the receiver, is the device that allows to solve the issue.

Optical filters able to tune over a sufficiently high number of wavelengths (e.g. 20 WDM channels, 100 GHz spaced in the C band) are the enabling technology of full tunable TRXs. However, they need to be set at the proper wavelength. Although this can be done manually, an automated procedure is desirable to reduce the network provisioning costs by means of plug&play devices, that reduce the installation times and do not require sending in field highly specialized personnel. Enabling remote reconfiguration of the wavelength allocation, rather than manually replacing the filters at the ONUs.

Automatically configuring a tunable filter at the ONU receiver is not trivial since no control channel signal can reach it until the right wavelength is set. Moreover, since in practical systems transmitted and received wavelengths are not independent but paired (e.g. separated by a fixed interval often referred to as free spectral range, FSR), setting the wrong received wavelength will result in setting the wrong transmitted wavelength, which can result in jamming another channel, known as ‘rogue ONT’.

### SUMMARY

It is an object to provide an improved optical network unit, ONU, for a passive optical network, PON. It is a further object to provide an improved a central office, CO, node for a PON. It is a further object to provide an improved method of configuring an ONU of a PON. It is a further object to provide an improved method of controlling an operating wavelengths of an ONU of a passive optical network, PON.

An aspect of the invention provides an optical network unit, ONU, for a passive optical network, PON. The ONU comprises a tunable receiver having a tunable operating wavelength, a tunable transmitter having a tunable operating wavelength, and a controller. The controller comprises at least one processor and memory containing instructions executable by the at least one processor whereby the ONU is operative to, if the tunable transmitter is on, switch the tunable transmitter off and if the tunable receiver is off, switch the tunable receiver on. The ONU is further operative to determine a downstream control channel wavelength. The ONU is further operative to set an operating wavelength of the tunable receiver to the downstream control channel wavelength. The ONU is further operative to receive a downstream control channel signal at the downstream control channel wavelength from a central office, CO, node of the PON. The downstream control channel signal carries an indication of an allocation of channel wavelengths to ONUs. The ONU is further operative to obtain allocated downstream and upstream channel wavelengths for the ONU from the indication of an allocation of channel wavelengths to ONUs. The ONU is further operative to set an operating wavelength of the tunable receiver to the allocated downstream channel wavelength and set the operating wavelength of the tunable transmitter to the allocated upstream channel wavelength. The ONU is further operative to switch the tunable transmitter on.

Advantageously, a full-tunable ONU for a PON is provided that is able to automatically (i.e. without requiring manual intervention) set both tunable receiver and tunable transmitter at the correct operating wavelength without disrupting existing operational channels. The ONU enables the tunable transmitter to be switched on for upstream communication traffic when the ONU knows the assigned operating wavelength, advantageously avoiding the ONU jamming already operating channels during configuring of the ONU.

The ONU is advantageously enabled for use in a PON having a power splitter at the distribution node, DN, i.e. the DN is not wavelength selective and lets all of the wavelengths of the PON wavelength grid concurrently pass through it. The ONU enables higher production volumes for full-tunable WDM ONUs, with associated cost reduction. It makes it possible for operators to buy a low number of spare parts, to deal with unpredictable traffic evolution without waste of bandwidth, allowing ONUs to switch-on and switch-off in a random sequence. The ONU supports all relevant network operations, including network installation, fault recovery, and network reconfiguration. The ONU enables a dynamic reconfiguration of a wavelength allocation plan.

In an embodiment, to determine a downstream control channel wavelength the ONU is operative to set the operating wavelength of the tunable receiver to a default downstream control channel wavelength. The ONU is further operative to determine receipt or absence of a downstream channel signal at the set operating wavelength of the tunable receiver. The ONU is further operative to, in response to determining receipt of a downstream channel signal at the set operating wavelength of the tunable receiver, determine that the received downstream channel signal includes a control channel identification and that the set operating wavelength of the tunable receiver is therefore the downstream control channel wavelength. The ONU is thus able to determine the downstream control channel wavelength without sending any communication to the CO node, advantageously avoiding disrupting communications of existing operational ONUs.

In an embodiment, to determine a downstream control channel wavelength the ONU is further operative to, in response to determining absence of a downstream channel signal at the set operating wavelength of the tunable receiver or that the received downstream channel signal does not include a control channel identification, set the operating wavelength of the tunable receiver to a different downstream channel wavelength of the PON and recommence to determine receipt or absence of a downstream channel signal at the set operating wavelength of the tunable receiver. The ONU is thus able to determine the downstream control channel wavelength by stepping through downstream channel wavelengths of the PON to identify the downstream control channel wavelength advantageously without sending any communication to the CO node, advantageously avoiding disrupting communications of existing operational ONUs.

In an embodiment, the ONU is further operative to transmit an upstream signal at the allocated upstream channel wavelength to the CO node. The ONU is further operative to, in response to determining an acknowledgement is received from the CO node, commence transmitting upstream traffic signals at the allocated upstream channel wavelength. Advantageously, the ONU only starts transmitting upstream traffic signals on the allocated upstream channel wavelength once the CO node has confirmed that this is the correct allocated wavelength, advantageously avoiding disrupting communications of existing operational ONUs.

In an embodiment, the ONU is further operative to, in response to determining an acknowledgement is not received from the CO node, switch the transmitter off and recommence to determine a downstream control channel wavelength. Advantageously, the ONU does not start to transmit upstream traffic signals on the allocated upstream channel wavelength if the CO node does not confirm that this is the correct allocated wavelength, advantageously avoiding disrupting communications of existing operational ONUs.

In an embodiment, the upstream signal includes an indication of an identification, ID, of the ONU. This advantageously enables the CO node to perform a simple cross check of the received upstream signal wavelength with the upstream wavelength allocated to the ONU by reference to its ID.

In an embodiment, the ONU is further operative to, in response to a loss of signal, LOS, alarm at the tunable receiver when the transmitter is switched on and transmitting upstream traffic signals at the allocated upstream channel wavelength, switch the transmitter off. The ONU is further operative to recommence to determine a downstream control channel wavelength. This advantageously enables the ONU to receive signalling from the CO node to determine a new downstream control channel wavelength, enabling the CO node to change the downstream control channel wavelength and/or the allocation of channel wavelength to ONUs on the fly.

Corresponding embodiments and advantages apply also to the passive optical network and the method of configuring an optical network unit, ONU, of a passive optical network described below.

An aspect of the invention provides a central office, CO, node for a passive optical network, PON. The CO node comprises a plurality of optical line terminations, OLTs, and a controller. The OLTs are operable at respective channel wavelengths of a PON. One of the OLTs is allocated to a control channel. The controller comprises at least one processor and memory containing instructions executable by the at least one processor whereby the CO node is operative to allocate the channel wavelengths to ONUs of the PON. The CO node is further operative to transmit, on a downstream control channel signal from the allocated OLT at a downstream control channel wavelength, an indication of the allocation of channel wavelengths to ONUs of the PON.

The CO node may implement concurrent configuration of a plurality of ONUs without any need of synchronization of the operations at ONU and CO node for all relevant network operations: network installation; fault recovery; network reconfiguration. The CO node may enable management of simultaneous switch on of multiple ONUs. The CO node may enable network operators to buy a low number of spare tunable ONUs, to deal with unpredictable traffic evolution without waste of bandwidth, enabling ONUs to switch-on and switch-off in a random sequence. Advantageously, the CO node is enabled to remotely control the operating wavelengths of full-tunable ONUs of a PON without disrupting existing operational channels. The CO node enables a dynamic reconfiguration of a wavelength allocation plan.

The CO node is advantageously enabled for use in a PON having a power splitter at the distribution node, DN, i.e. the DN is not wavelength selective and lets all of the wavelengths of the PON wavelength grid concurrently pass through it. The CO node enables higher production volumes for full-tunable WDM ONUs, with associated cost reduction. It makes it possible for operators to buy a low number of spare parts, to deal with unpredictable traffic evolution without waste of bandwidth, allowing the CO node to control the operating wavelengths of ONUs as they switch-on and switch-off in a random sequence, without requiring synchronization. The CO node supports all relevant network operations, including network installation, fault recovery, and network reconfiguration.

In an embodiment, the CO node is operative to allocate channel wavelengths to ONUs until all the channel wavelengths except the control channel wavelengths have been allocated to ONUs and to then allocate the control channel wavelengths to an ONU. The control channel may be advantageously converted to an ONU traffic channel when the traffic request exhausts the capacity of the other downstream channels, which may avoid any waste of bandwidth since wavelengths are not permanently allocated to the control channel.

In an embodiment, the CO node is operative to continuously transmit the indication of the channel wavelengths allocated to ONUs on the downstream control channel signal until all the channel wavelengths are allocated to ONUs. This may enable the CO to implement concurrent configuration of a plurality of ONUs without any need of synchronization of the operations at ONU and CO node.

In an embodiment, the CO node is further operative to receive identifications, IDs, of ONUs of the PON from a management system of the PON. To allocate the channel wavelengths to ONUs the CO node is operative to allocate the channel wavelengths to the ONU IDs.

In an embodiment, the CO node is further operative to receive an upstream signal from an ONU on an upstream channel at an upstream channel wavelength. The upstream signal includes an indication of an identification, ID, of the ONU. The CO node is further operative to, in response to determining that the upstream channel wavelength of the received upstream signal matches the upstream channel wavelength allocated to the ONU ID, send an acknowledgement to the ONU. This may enable the CO node to confirm that an ONU is using a current wavelength allocation and confirm the wavelength allocation to the ONU.

In an embodiment, the CO node is further operative to, in response to determining that a channel wavelength of the upstream channel does not match the channel wavelength allocated to the ONU ID, not send an acknowledgement to the ONU. This may enable the CO node to cause the ONU to recommence to determine a downstream control channel wavelength.

In an embodiment, the CO node is further operative to change the allocation of channel wavelengths to ONUs of the PON. The CO node is further operative to stop transmitting downstream signals to ONUs having different allocated channel wavelengths as a result of the change. The may enable the CO node to change the ONU wavelength allocation and to cause affected ONUs to obtain a changed allocation of channel wavelengths from the control channel. The may enable the allocation of channel wavelengths to ONUs to be upgraded and modified dynamically according to the needs of the network. The CO node may therefore implement fast reconfiguration of one or more traffic channels, simply rewriting the allocated channel wavelengths and forcing the switch off of the affected ONUs and causing them to obtain new allocated downstream and upstream channel wavelengths from the changed allocation of channel wavelengths.

In an embodiment, IDs of ONUs include tuning ranges of ONU tunable receivers. The CO node is further operative to allocate to the control channel an OLT having a downstream wavelength falling within tuning ranges of the tunable receivers of the ONUs of the PON. This may enable the CO node to allocate a downstream wavelength to the control channel that is common to the tuning ranges of a plurality of ONUs of the PON, to advantageously ensure that the control channel reaches each of said plurality of ONUs.

In an embodiment, the CO node is further operative to allocate to the control channel a first OLT having a first downstream wavelength falling within a tuning range of a first set of ONU tunable receivers and a second OLT having a second downstream wavelength falling within a tuning range of a second set of ONU tunable receivers, the second tuning range not overlapping with the first tuning range. This may enable the CO node to allocate two or more downstream wavelengths to the control channel in the case there is one or more ONU that does not have a wavelength in common with tuning ranges of other ONUs of the PON, to advantageously ensure that the control channel reaches all ONUs of the PON.

The CO node may therefore manage full tunable ONUs having different wavelength range of tunability both in case there is a common wavelength across the tuning ranges and in the case where subsets of ONUs have different wavelengths in common.

In an embodiment, the CO node is further operative to receive, from a management system of the PON, an indication that the downstream channel wavelength used for the downstream control channel is to be allocated to an ONU and an indication of a different channel wavelength to be used for the downstream control channel. The CO node is further operative to stop transmitting the downstream control channel signal from the allocated OLT. The CO node is further operative to update the allocation of channel wavelengths to ONUs of the PON. The CO node is further operative to transmit, on a downstream control channel signal from an allocated OLT at the different downstream control channel wavelength, an indication of the updated allocation of channel wavelengths to ONUs of the PON. This may enable the CO node to change the channel wavelengths used for the control channel on the fly.

In an embodiment, the downstream control channel signal includes a control channel identifier. This advantageously enables ONUs to determine whether a downstream signal received from the CO node at a default control channel wavelength is a control channel signal.

Corresponding embodiments and advantages apply also to the passive optical network and the method at a central office, CO, node of a passive optical network, PON, of controlling operating wavelengths of an optical network unit. ONU, of the PON described below.

An aspect of the invention provides a passive optical network comprising a central office, CO, node, a plurality of optical network units, ONUs, and a wavelength agnostic distribution node connected to the CO by a feeder fibre and connected to the plurality of ONUs by a plurality of drop fibres. The CO node comprises a plurality of optical line terminations, OLTs, and a controller. The OLTs are operable at respective channel wavelengths of a PON. One of the OLTs is allocated to a control channel. The controller comprises at least one processor and memory containing instructions executable by the at least one processor whereby the CO node is operative to allocate the channel wavelengths to ONUs of the PON. The CO node is further operative to transmit, on a downstream control channel signal from the allocated OLT at a downstream control channel wavelength, an indication of the allocation of channel wavelengths to ONUs of the PON Each ONU comprises a tunable receiver having a tunable operating wavelength, a tunable transmitter having a tunable operating wavelength, and a controller. The controller comprises at least one processor and memory containing instructions executable by the at least one processor whereby the ONU is operative to, if the tunable transmitter is on, switch the tunable transmitter off and if the tunable receiver is off, switch the tunable receiver on. The ONU is further operative to determine a downstream control channel wavelength. The ONU is further operative to set an operating wavelength of the tunable receiver to the downstream control channel wavelength. The ONU is further operative to receive a downstream control channel signal at the downstream control channel wavelength from a central office, CO, node of the PON. The downstream control channel signal carries an indication of an allocation of channel wavelengths to ONUs. The ONU is further operative to obtain allocated downstream and upstream channel wavelengths for the ONU from the indication of an allocation of channel wavelengths to ONUs. The ONU is further operative to set an operating wavelength of the tunable receiver to the allocated downstream channel wavelength and set the operating wavelength of the tunable transmitter to the allocated upstream channel wavelength. The ONU is further operative to switch the tunable transmitter on.

In an embodiment, the passive optical network further comprises a plurality of legacy optical line terminations, OLTs, at the CO, a plurality of legacy ONUs, a first coexistence filter and at least one further coexistence filter. The first coexistence filter couples the OLTs and the legacy OLTs to the feeder fibre. The at least one further coexistence filter couples an ONU and a legacy ONU to the distribution node.

An aspect of the invention provides a method of configuring an optical network unit, ONU, of a passive optical network. The ONU comprises a tunable transmitter and a tunable receiver. The method comprises the following steps. A step of, if the tunable transmitter is on, switching the tunable transmitter off and if the tunable receiver is off, switching the tunable receiver on. A step of determining a downstream control channel wavelength. A step of setting an operating wavelength of the tunable receiver to the downstream control channel wavelength. A step of receiving a downstream control channel signal at the downstream control channel wavelength from a central office, CO, node of the PON. The downstream control channel signal carries an indication of an allocation of channel wavelengths to ONUs. A step of obtaining allocated downstream and upstream channel wavelengths for the ONU from the indication of an allocation of channel wavelengths to ONUs A step of setting an operating wavelength of the tunable receiver to the allocated downstream channel wavelength and setting the operating wavelength of the tunable transmitter to the allocated upstream channel wavelength. A step of switching the tunable transmitter on.

The method is compliant with any radio architectures, any transport architecture (e.g. configured by SDN controller and/or Network Management System) and future proof for ORAN. The method enables a dynamic reconfiguration of the wavelengths allocation plan, so that at the CO the information on allocated channels and non-allocated channels is always available.

An aspect of the invention provides a method at a central office, CO, node of a passive optical network, PON, of controlling operating wavelengths of an optical network unit, ONU, of the PON. The CO node comprises a plurality of optical line terminations, OLTs, operable at respective channel wavelengths of the PON. One of the OLTs is allocated to a control channel. The method comprising the following steps. A step of allocating the channel wavelengths to ONUs of the PON and a step of transmitting, on a downstream control channel signal from the allocated OLT at a downstream control channel wavelength, an indication of the allocation of channel wavelengths to ONUs of the PON.

The method is compliant with any radio architectures, any transport architecture (e.g. configured by SDN controller and/or Network Management System) and future proof for ORAN. The method enables a dynamic reconfiguration of the wavelength allocation plan.

Advantageously, the method is asynchronous and enables the management of simultaneous switch on of multiple ONUs.

An aspect of the invention provides computer program, comprising instructions which, when executed on at least one processor, cause the at least one processor to carry out steps of the above method of configuring an optical network unit, ONU, of a passive optical network.

An aspect of the invention provides computer program, comprising instructions which, when executed on at least one processor, cause the at least one processor to carry out steps of the above method at a central office, CO, node of a passive optical network, PON, of controlling operating wavelengths of an optical network unit, ONU, of the PON.

Embodiments of the invention will now be described, by way of example only, with reference to the accompanying drawings.

### BRIEF DESCRIPTION OF THE DRAWINGS

FIGS. 1 and 2 are block diagrams illustrating embodiments of an optical network unit, ONU, for a passive optical network, PON;

FIG. 3 is a block diagram illustrating an embodiment of a central office, CO, node for a PON;

FIGS. 4 and 5 are block diagrams illustrating embodiments of a passive optical network, PON, and

FIGS. 6 to 9 are flowcharts illustrating embodiments of method steps.

### DETAILED DESCRIPTION

The same reference numbers are used for corresponding features in different embodiments.

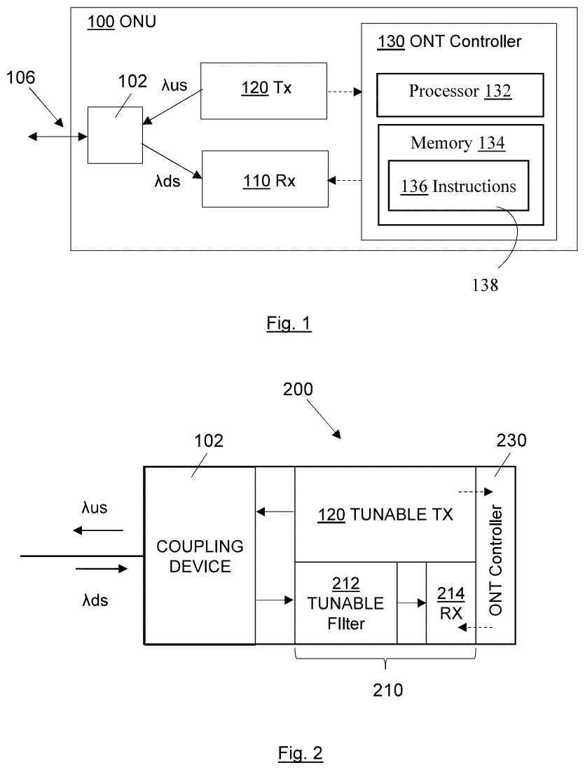

An embodiment, shown in FIG. 1, provides an optical network unit, ONU, 100 for a passive optical network, PON. The ONU comprises a tunable receiver, Rx, 110 having a tunable operating wavelength, a tunable transmitter, Tx, 120 having a tunable operating wavelength and a coupling device 102 arranged to couple the tunable Rx and the tunable Tx to an input/output port of the ONU. The ONU also comprises a controller 130.

The controller 130 comprises at least one processor and memory containing instructions executable by the at least one processor whereby the ONU is operative as follows.

The ONU is operative to, if the tunable transmitter is on, switch the tunable transmitter off and if the tunable receiver is off, switch the tunable receiver on.

For example, if the ONU is not yet installed in the PON, meaning the tunable transmitter 120 and the tunable receiver 110 are currently switched off, the tunable receiver is switched on. If the ONU is already installed in the PON and has been operating at previously allocated operating wavelengths, meaning the tunable transmitter 120 and the tunable receiver 110 are currently switched on, the tunable transmitter is switched off.

The ONU is operative to determine a downstream control channel wavelength and to set an operating wavelength of the tunable receiver to the downstream control channel wavelength. The ONU is operative to receive a downstream control channel signal at the downstream control channel wavelength from a central office, CO, node of the PON. The downstream control channel signal carries an indication of an allocation of channel wavelengths to ONUs. The ONU is operative to obtain an allocated downstream wavelength, λ_{DS}, and an allocated upstream channel wavelength, λ_{US}, for the ONU from the indication of an allocation of channel wavelengths to ONUs.

The ONU is operative to set an operating wavelength of the tunable receiver to the allocated downstream channel wavelength and to set the operating wavelength of the tunable transmitter to the allocated upstream channel wavelength, and to then switch the tunable transmitter on.

The PON may comprise a wavelength agnostic (i.e. non-wavelength selective) distribution node, such as a passive splitter.

In an embodiment, the indication of an allocation of channel wavelengths to ONUs is a wavelengths allocation table. The ONU is operative to receive the wavelengths allocation table on the downstream control channel and to read its allocated downstream and upstream channel wavelengths from the wavelengths allocation table.

An embodiment, shown in FIG. 2, provides an optical network unit, ONU, 200 for a passive optical network, PON. As the skilled person will know, an ONU may also known as an optical network termination, ONT. The ONU comprises a tunable receiver 210 having a tunable operating wavelength, a tunable transmitter, Tx, 120 having a tunable operating wavelength and a controller 230.

The tunable receiver 210 comprises a tunable filter 212 having a wavelength tunable passband and a receiver, Rx, 214. In this embodiment, the ONU is operative to set the operating wavelength of the tunable receiver to the allocated downstream channel wavelength by setting the wavelength of the passband of the tunable filter 212 to the allocated downstream channel wavelength.

In an embodiment, to determine a downstream control channel wavelength, the ONU 100, 200 is operative to set the operating wavelength of the tunable receiver to a default downstream control channel wavelength. The ONU is operative to then determine receipt or absence of a downstream channel signal at the set operating wavelength of the tunable receiver. The ONU is operative, in response to determining receipt of a downstream channel signal at the set operating wavelength of the tunable receiver, to determine that the received downstream channel signal includes a control channel identification, ID, and that the set operating wavelength of the tunable receiver is therefore the downstream control channel wavelength.

In an embodiment, the ONU 100, 200 is further operative, in response to determining absence of a downstream channel signal at the set operating wavelength of the tunable receiver or that the received downstream channel signal does not include a control channel identification, to set the operating wavelength of the tunable receiver to a different downstream channel wavelength of the PON and to then recommence to determine receipt or absence of a downstream channel signal at the set operating wavelength of the tunable receiver, i.e. at the currently set, different downstream channel wavelength.

In an embodiment, the ONU 100, 200 is further operative to transmit an upstream signal at the allocated upstream channel wavelength to the CO node. In response to determining an acknowledgement is received from the CO node, the ONU is operative to commence transmitting upstream traffic signals at the allocated upstream channel wavelength.

In an embodiment, the ONU 100, 200 is operative, in response to determining an acknowledgement is not received from the CO node, to switch the transmitter off and recommence to determine a downstream control channel wavelength.

In an embodiment, the ONU 100, 200 is operative to transmit the upstream signal to the CO node, at the allocated upstream channel wavelength, including an indication of an identification, ID, of the ONU.

In an embodiment, the ONU 100, 200 is further operative to, in response to a loss of signal, LOS, alarm at the tunable receiver when the transmitter is switched on and transmitting upstream traffic signals at the allocated upstream channel wavelength, switch the transmitter off. The ONU is further operative to then recommence to determine a downstream control channel wavelength.

In an embodiment, the ONU 200 is operative to find the downstream wavelength used by the control channel by setting the passband wavelength of the tunable filter 212 to a default downstream control channel wavelength stored in its memory. The ONU then receives the downstream control channel and obtains the wavelengths allocation table from the downstream control channel. The ONU reads the downstream and upstream channel wavelengths assigned to it from the wavelengths allocation table. The ONU then sets the wavelength of the tunable receiver 210, i.e. the wavelength of the tunable filter 212, and the wavelength of the tunable transmitter 120 accordingly. The ONU verifies that no optical power is received at its allocated downstream channel wavelength then switches on the transmitter and sends an upstream signal on its allocated upstream channel wavelength carrying an acknowledge, ACK, request to the CO node. If the ONU receives an ACK receipt from the CO node, the ONU can start transmission of upstream traffic signals on the allocated upstream channel. If the procedure fails, i.e. if the ONU detects optical power at its allocated downstream channel wavelength or does not receive an ACK receipt from the CO node, the ONU switches off its transmitter and sets the tunable filter back to the default control channel wavelength and repeats the process of obtaining its allocated channel wavelengths, which may have been changed by the CO node during the time taken by the ONU to perform the process.

In an embodiment, the ONU 200 is operative, following being plugged in, to configure its downstream and upstream channel wavelengths as follows. A default wavelength for the control channel is defined in memory of the ONU controller 230. The ONU is operative to set the tunable filter at the receiver to the default control channel wavelength and leaves its transmitter 120 switched off and unprogrammed.

The ONU is operative to receive a downstream signal from a CO node and to verify whether a downstream signal received at the default control channel wavelength is, in fact, the control channel, by determining whether the received downstream signal has an expected control frame identifying it as the control channel. The ONU is operative to, if the received channel is not the control channel, for example if it is a downstream traffic signal of another ONU and therefore does not have a control channel ID, set the tunable filter to another downstream channel wavelength within the tuning range of the tunable receiver and restarts to determine the downstream control channel wavelength. The ONU is operative to, if the received channel is the control channel, obtain a wavelengths allocation table from the control channel signal and read the downstream and upstream wavelength pair allocated in the wavelength allocation table to its ID. The ONU is operative to set the tunable transmitter and the tunable filter 212 to the wavelengths assigned its ID. The transmitter remains switched-off.

The ONU is operative to check whether its assigned downstream channel wavelength is the same as the current control channel wavelength. The ONU is operative, in case of a positive match, to check a loss of signal, LOS, alarm at its receiver 214. The ONU is operative, if a LOS alarm is present (indicating no downstream optical power is detected at the receiver), the ONU sends an upstream signal to the CO node on it allocated upstream wavelength, the upstream signal requesting acknowledgement from the CO node and includes the ONU's ID.

The ONU is operative to, if it receives an acknowledged, ACK, response from the CO node, to start to send and receive traffic on its allocated channel wavelengths. The ONU is operative to, if it receives no acknowledgement response within a pre-set period of time or if it receives a ‘not acknowledged’, NACK, response from the CO node, to infer that the procedure has not been successful and to recommence to determine the control channel wavelength and obtain the wavelength allocation table.

If a LOS alarm is not present (indicating downstream optical power is detected at the receiver) this means that a wrong downstream wavelength has been assigned to the ONU's ID, the ONU is operative in response to no LOS alarm to recommence to determine the control channel wavelength, selecting a different downstream channel wavelength to try.

The ONU is operative to, in response to a loss of signal, LOS, alarm at the tunable receiver when the transmitter is switched on and transmitting upstream traffic signals at the allocated upstream channel wavelength, switch the transmitter off and recommence to determine a downstream control channel wavelength.

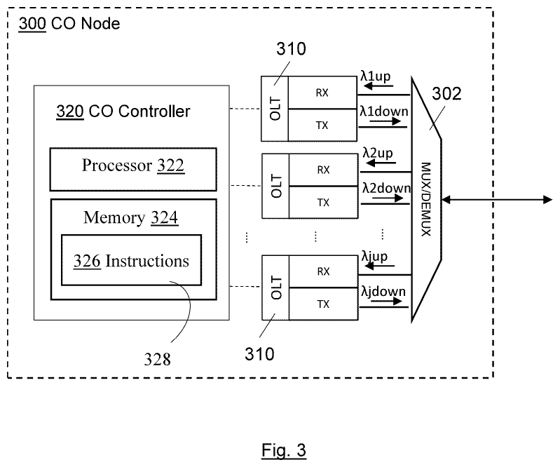

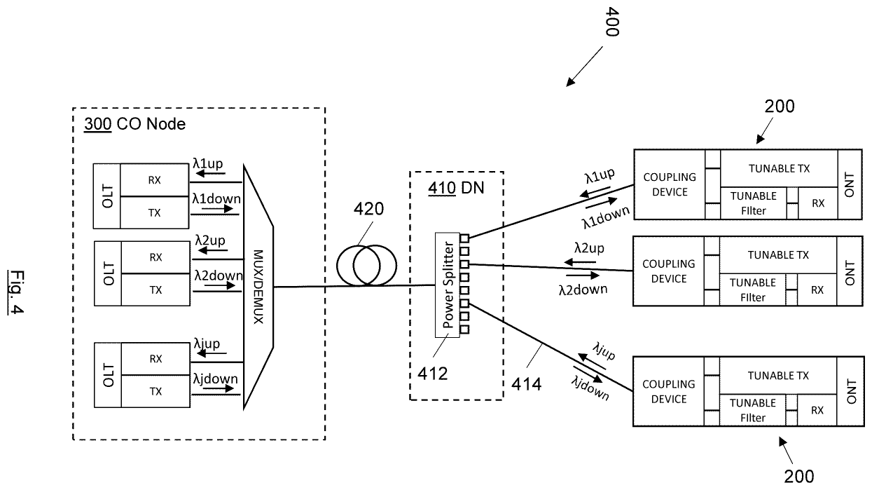

Referring to FIG. 3, an embodiment provides a central office, CO, node 300 for a passive optical network, PON. The CO node comprises a plurality of optical line terminations, OLTs, 310 and a controller 320.

The OLTs are operable at respective channel wavelength pairs (λ1up, λ1down, . . . λjup, λjdown) of the PON; one of the OLTs, and its wavelength pair, is allocated to a control channel. A multiplexer/demultiplexer 302 couples the OLTs to a transmission fibre. The multiplexer/demultiplexer multiplexes the j WDM downstream wavelengths (λ1down, λ2 down, λ3 down . . . , λjdown) for transmission on the transmission fibre and demultiplexes the upstream wavelengths (λ1up, λ2up, λ3up . . . , λjup) received from the transmission fibre.

The controller 320 comprises a processor and memory containing instructions executable by the at least one processor whereby the CO node is operative as follows.

The CO node is operative to allocate the channel wavelength pairs of the PON to ONUs of the PON. The CO node is operative to transmit, on a downstream control channel signal from the allocated OLT at the allocated downstream control channel wavelength, an indication of the allocation of channel wavelengths to ONUs of the PON.

In an embodiment, the indication of an allocation of channel wavelengths to ONUs is a wavelengths allocation table. The CO node 300 is operative to transmit the wavelengths allocation table on the downstream control channel.

In an embodiment, the wavelength allocation table is provided to the CO node from a transport controller (for example, in a software defined networking SDN, implementation), a radio/mobile network (for example, a Base Band unit in case of Centralized RAN), a Network management System, or a Command Line Interface, CLI.

The wavelengths in the wavelengths table may be modified dynamically for several reasons including:
when some wavelengths are assigned to other transceivers for any reason
when a fault occurs on the transport network impacting the use of the wavelength
when a fault occurs at the mobile network using the WDM overlay and the corresponding wavelength cannot be used.

In an embodiment, the CO node 300 is operative to allocate channel wavelengths to ONUs until all the channel wavelengths except the control channel wavelengths have been allocated to ONUs and to then allocate the control channel wavelengths to an ONU.

In an embodiment, the CO node 300 is further operative to receive identifications, IDs, of ONUs of the PON from a management system of the PON. The CO node is operative to allocate channel wavelengths to ONUs by allocating channel wavelengths to the ONU IDs.

In an embodiment, the memory 324 further contains a wavelengths allocation table containing channel wavelength pairs (λ1up, λ1down, . . . λjup, λjdown) of the PON. The CO node 300 is operative to allocate channel wavelength pairs in the wavelengths allocation table to ONUs until all wavelengths within the wavelengths allocation table have been allocated to ONUs. Once all the wavelengths have been allocated, the CO node uses the control channel wavelength pair as operating wavelengths for a last installed ONU If an ONU goes out of service, the CO node can reallocate the channel wavelength pair of that ONU as a new control channel wavelength pair.

In an embodiment, the CO node 300 is operative to allocate channel wavelength pairs to the ONU IDs in the wavelengths allocation table.

In an embodiment, the CO node 300 is operative to continuously transmit the indication of the channel wavelengths allocated to ONUs on the downstream control channel signal until all the channel wavelengths are allocated to ONUs.

In an embodiment, the CO node 300 is further operative to receive an upstream signal from an ONU on an upstream channel at an upstream channel wavelength. The upstream signal includes an indication of an ID of the ONU sending the upstream signal. The CO node is operative, in response to determining that the upstream channel wavelength of the received upstream signal matches the upstream channel wavelength allocated to the ONU ID, to send an acknowledgement to the ONU.

In an embodiment, the CO node 300 is further operative, in response to determining that the channel wavelength of the upstream channel received from the ONU does not match the upstream channel wavelength allocated to the ONU ID, to not send an acknowledgement to the ONU.

In an embodiment, the CO node 300 is further operative to change the allocation of channel wavelengths to ONUs of the PON. The CO node 300 is operative, in response to changing the allocation of channel wavelengths, to stop transmitting downstream signals to ONUs having different allocated channel wavelengths as a result of the change.

In an embodiment, received IDs of ONUs include tuning ranges of ONU tunable receivers. The CO node 300 is further operative to allocate to the control channel an OLT having a downstream wavelength falling within tuning ranges of the tunable receivers of the ONUs of the PON.

In an embodiment, the CO node 300 is further operative to allocate a first downstream wavelength, of a first OLT 310, and a second downstream wavelength, of a second OLT 310, to the control channel. The first downstream wavelength falls within a tuning range of a first set of ONU tunable receivers and the second downstream wavelength falls within a tuning range of a second set of ONU tunable receivers. The second tuning range does not overlap with the first tuning range, i.e. the tuning ranges of the tunable receivers of the first set of ONUs do not overlaps with the tuning ranges of the tunable receivers of the second set of ONUs.

In an embodiment, the CO node 300 is further operative to receive, from a management system of the PON, an indication that the downstream channel wavelength used for the downstream control channel is to be allocated to an ONU and an indication of a different channel wavelength to be used for the downstream control channel. The CO node is operative, in response, to stop transmitting the downstream control channel signal from the allocated OLT and to update the allocation of channel wavelengths to ONUs of the PON. The CO node is operative to then transmit, on a downstream control channel signal from an allocated OLT at the different downstream control channel wavelength, an indication of the updated allocation of channel wavelengths to ONUs of the PON.

In an embodiment, the CO node is operative to transmit the downstream control channel signal including a control channel identifier.

In an embodiment, the CO node is operative to frame information carried by the control channel signals. For the DS control channel signal, some bytes of the frame overhead are used to provide the control channel identifier.

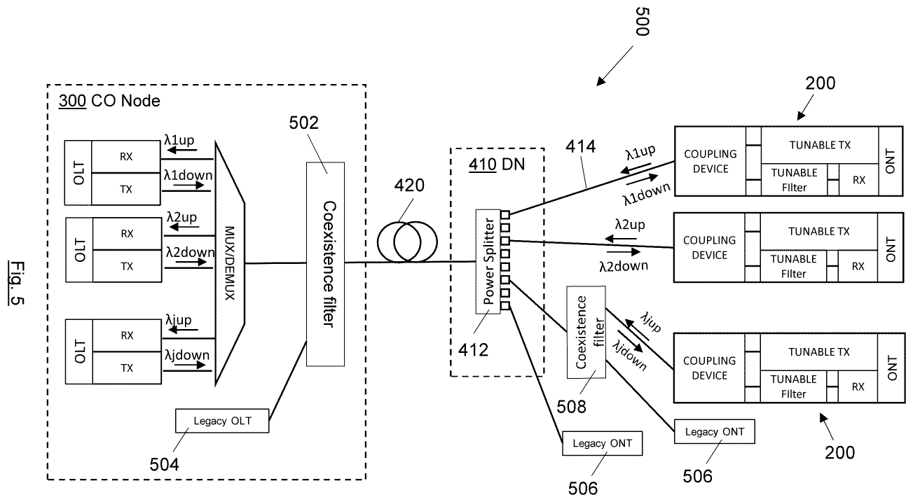

Referring to FIG. 4, an embodiment provides a passive optical network, PON, 400 comprising a central office, CO, node 300, optical network units, ONUs, 200 and a distribution node, DN, 410.

The CO node 300 is as described above with reference to FIG. 3. The OLTs of the CO node may be fixed wavelength ONTs or may be full tunable ONTs.

The ONUs 200 are as described above with reference to FIG. 2, although it will be appreciated that ONUs 100 as described above with reference to FIG. 1 may alternatively be used. Each ONU has respective allocated operating wavelengths, λ1ᵤₚ, λ1_{down} . . . λjᵤₚ, λj_{down}.

The DN 410 is a wavelength agnostic DN comprising a conventional passive power splitter 412 with typical splitting ratios of 1:16, 1:32, 1:64 or 1:128. The DN is connected to the CO 300 by a feeder fiber 420 and is connected to the ONUs 200 by respective drop fibers 414.

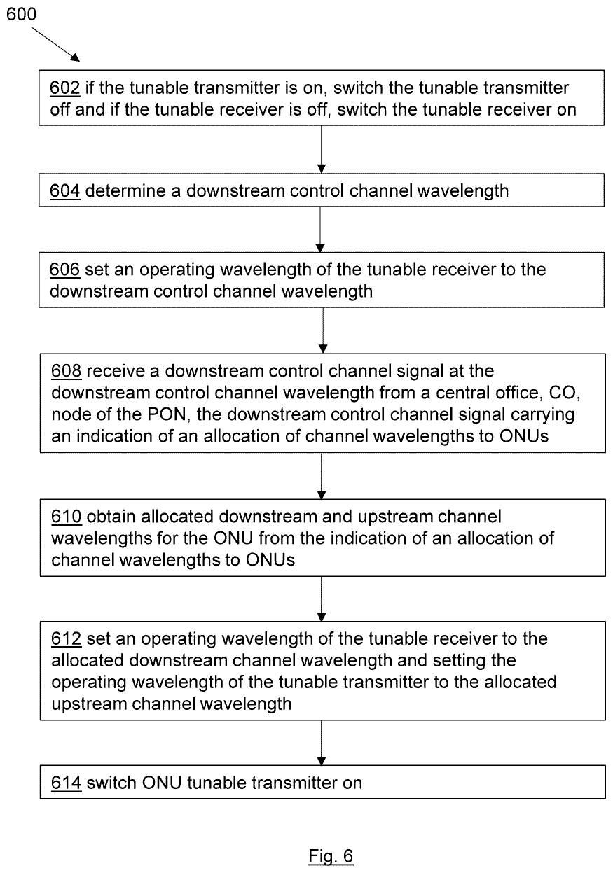

In an embodiment, illustrated in FIG. 5, the PON 500 further comprises a plurality of legacy optical line terminations, OLTs, 504 at the CO node 300 and a plurality of legacy ONUs 506. A first coexistence filter 502 couples the OLTs and the legacy OLTs to the feeder fiber and a further coexistence filter 508 couples an ONU 200 and a legacy ONU 506 to the DN 410. Alternatively, the further coexistence filter 508 may be provided before the DN 410.

FIG. 5 illustrates the concept of overlay of a WDM system comprising the CO node 300 functionality of FIG. 3 and ONUs 100, 200 of FIG. 1 or FIG. 1 2 on an existing, legacy time division multiplexing, TDM, PON. The WDM system may be used for mobile services while the legacy TDM PON continues to be used for transport of other communications traffic. WDM channels are transmitted from the CO node, to the full tunable transceivers at the ONUs located at remote sites, for example antenna sites. The coexistence filters multiplex and demultiplex PON legacy signals with the WDM channels on the same feeder fiber, coupling the WDM systems used for mobile services to the legacy PON.

The CO node 300 comprises:
OLTs 504 for WDM transmission; fixed wavelength transmitters or tunable transmitters may be used.
passive MUX/DEMUX device 302, for example a diplexer, this multiplexes transmitted downstream channel wavelengths and demultiplexes received upstream channel wavelengths. (In the case of transmitter with tunable filters, the MUX/DEMUX is replaced by splitter(s))
first coexistence optical filter 502; this multiplexes and demultiplexes PON legacy signals with WDM channels on the feeder fiber 420.
PON legacy OLT 504 sharing the PON infrastructure with the WDM channels.

The further coexistence filter 508 is provided between the DN and one of the ONUs 200 and a legacy ONU 506. This multiplexes and demultiplexes PON legacy signals with WDM channels on the respective drop fiber 414.

As described above, each ONU 200 comprises a fully tunable transceiver (tunable TX 120 and tunable RX 210) and a coupling device to combine the upstream and downstream signals on the respective drop fiber 414. The tunable TX 120 comprises a programmable tunable laser and the tunable RX 210 comprises an RX 214 and a programmable tunable filter 212 that selects the desired wavelength.

The full-tunable ONU 200 can receive and transmit all the WDM wavelengths in the allocated spectrum of the WDM channels. The ONU 200 enables setting both tunable filter and tunable laser at the correct allocated operating wavelengths without disrupting channels that are already operational. Since the power splitter 412 at the DN 410 is not wavelength selective (i.e. it lets all wavelengths pass through it), this means that the tunable laser is switched on only when it knows its allocated operating wavelength, avoiding jamming already operating channels. The tunable filter plays a fundamental role since its bandpass transfer function can be tuned without disturbing the existing channels and, once the correct wavelength is found for the control channel, the transmitter is set to the upstream control channel wavelength and transmits an upstream signal to the CO node with a notification of the ONU ID, so that the CO can confirm that the ONU is operating at the correct allocated upstream channel wavelength and communication of traffic can safely start.

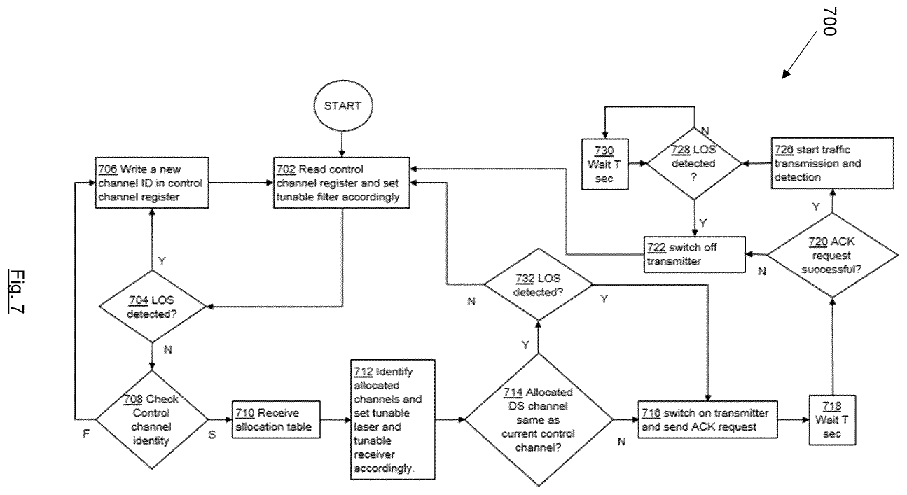

Referring to FIG. 6, an embodiment provides a method 600 of configuring an ONU of a PON, the ONU comprising a tunable transmitter and a tunable receiver.

The method comprises steps of
if 602 the tunable transmitter is on, switching the tunable transmitter off and if the tunable receiver is off, switching the tunable receiver on;
determining 604) a downstream control channel wavelength;
setting 606 an operating wavelength of the tunable receiver to the downstream control channel wavelength;
receiving 608 a downstream control channel signal at the downstream control channel wavelength from a CO node of the PON, the downstream control channel signal carrying an indication of an allocation of channel wavelengths to ONUs;
obtaining 610 allocated downstream and upstream channel wavelengths for the ONU from the indication of an allocation of channel wavelengths to ONUs;
setting 612 an operating wavelength of the tunable receiver to the allocated downstream channel wavelength and setting the operating wavelength of the tunable transmitter to the allocated upstream channel wavelength; and
switching 614 the tunable transmitter on.

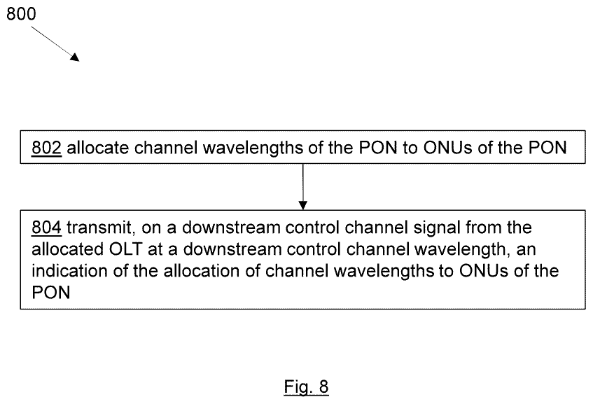

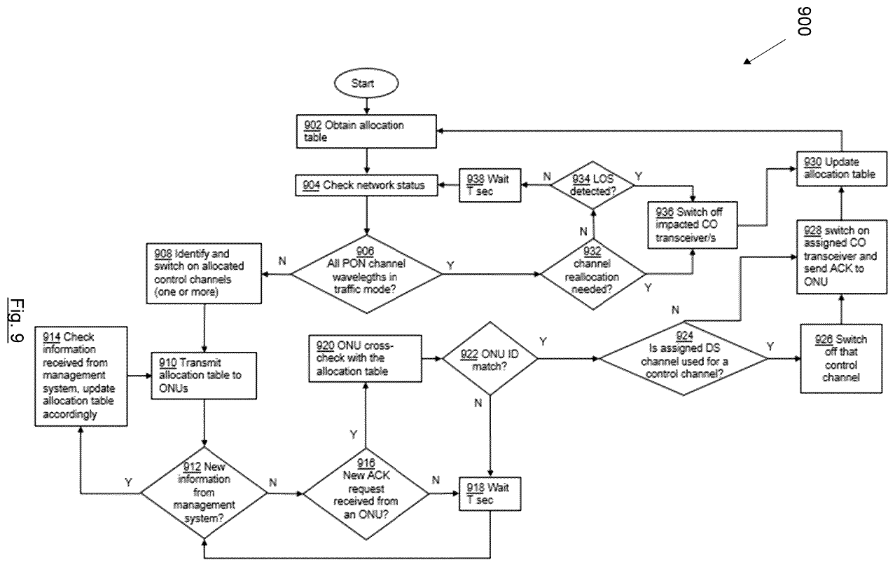

Referring to FIG. 8, an embodiment provides a method 800 at a CO node of a PON of controlling operating wavelengths of an ONU of the PON The CO node comprises a plurality of OLTs operable at respective channel wavelengths of the PON, one of the OLTs being allocated to a control channel.

The method comprises steps of
i. allocating 802 the channel wavelengths to ONUs of the PON; and
ii. transmitting 804, on a downstream control channel signal from the allocated OLT at a downstream control channel wavelength, an indication of the allocation of channel wavelengths to ONUs of the PON.

In an embodiment, the steps of the methods 600, 800 may be performed together, for example in relation to the PONs described above in FIG. 4 and FIG. 5. The combined method comprises the following steps:

1) Collecting Information from the Field:

When a new ONU 200 is plugged in a set of information, that enables the position and the identity of the ONU to be uniquely identified (for example, position, transceiver part number and serial number) is sent by an engineer installing the ONU to a management system of the PON, which provides 912 the information to the CO node 300.

### 2) Allocation of Channel Wavelengths:

The CO node 300 performs the allocation of channel wavelengths to the ONUs, on the basis of a policy provided by the network management system. When the management system receives the ID of a new ONU 200 that has been installed and registered on the network, the management system updates the wavelengths allocation table by allocating a pair of channel wavelengths (one for the tunable transmitter and one for the tunable filter of the receiver) to the ONU. The CO node downloads the updated wavelengths allocation table. The CO node continually periodically transmits 910 the wavelengths allocation table on the downstream control channel; the wavelengths allocation table contains all the channels wavelengths to ONU ID allocations. Transmission of the wavelengths allocation table is stopped only when all the channels of the network are in traffic mode.

### 3) ONU Configuration and Operation.

When the ONU has been plugged in, concurrently to the step 1), a configuration workflow starts. In this workflow a default wavelength is defined for the control channel, hence the ONU sets the tunable filter at its receiver to the default control channel wavelength and leaves its transmitter switched off and unprogrammed. The configuration workflow comprises:
a. The ONU receives a downstream signal from the CO node and verifies if the default channel is the channel in use as the control channel, the ONU looks for a control channel ID in the control frame in the received signal.
b. If the received channel is not the control channel (there is no signal and/or it is a traffic channel), the ONU sets the tunable filter to another channel wavelength within its wavelength tuning range and returns to “a.” otherwise the ONU proceeds to “c”.
c. If the received downstream channel is the control channel, then the ONU downloads the wavelengths allocation table and gets the wavelength channels allocated to its ID. Finally the ONU sets both the tunable transmitter and the tunable filter to the allocated wavelengths and proceeds to “d”. The transmitter stays switched-off.
d. The ONU checks if its allocated downstream channel is the same as the current control channel. In case of positive match the ONU proceeds to “e” otherwise it proceeds to “f”.
e. The ONU checks the LOS alarm on its receiver. If a LOS alarm is present (no downstream optical power detected) the ONU proceeds to the f. In case a LOS alarm is not present (optical power detected at the receiver) this means that a wrong downstream wavelength has been assigned to the ONU's ID, the procedure must to be repeated from the beginning, and the ONU recommences at “a”.
f. The ONU uses its allocated upstream wavelength to send an acknowledge, ACK, message and its ID to the CO node.
g. The CO node receives the ACK message and the ONU ID, and checks in the wavelengths allocation table if the wavelength of the received upstream signal matches with the upstream wavelength allocated to the ONU ID. If it matches, the CO node proceeds to “h”. otherwise proceeds to “l”.
h. The CO nodes sends an ACK response message to the ONU, the ONU starts to send/receive traffic on its allocated channels.
i. When an ONU is not recognized, the CO node sends to the ONU a “not acknowledge”, NACK, message or no message is sent to the ONU; after a predefined time out without any answer from the CO the ONU will infer that the procedure has failed. The ONU starts again the procedure to find the control channel (returns to “a”) and obtains again the wavelengths allocation table.
j. When the ONU is in traffic and a LOS is detected at its receiver, the ONU switches-off its transmitter and recommences at “a.”

In the case where are plurality of ONUs are installed concurrently, the same configuration procedure may be performed by each ONU independently to each other and without requiring any synchronization of operations between the CO node and the ONUs.

### 4) Fault Management:

When a fault occurs, a traffic link goes down and the CO node updates the wavelengths allocation table accordingly. If the fault is at the CO node no further update of the table is necessary. The ONU follows the configuration procedure waiting for a new OLT to be installed in the CO node.

If the fault is at an ONU, the CO nodes informs the management system and the management system removes the ID of the faulty ONU from the wavelengths allocation table. When an engineer replaces the ONU they then send the initial set of information uniquely identifying the ONU (i.e. position, part number and serial number) to the management system (as in step 1) then the management systems updates the wavelengths allocation table by allocating a pair of operative wavelengths to the newly registered ONU and finally downloads the new wavelengths allocation table in the CO node (as in step 2)). Step 3) then starts again.

### 5) Management of Control Channel on the Fly:

The control channel wavelength can be assigned and modified on the fly by the CO node for several reasons. Therefore the control channel wavelength may be different to the default control channel wavelength provided in the ONU memory and used by the ONU at the start of its configuration procedure.

Thanks to the procedure used by the ONU to identify the control channel, iterating from “a” to “b” above for channel wavelengths within the tunable wavelength range of the ONU, the CO node can change on the fly the control channel wavelength. In case the CO node assigns the control channel to a wavelength used for traffic by a ONU, it switches off the control channel and updates the wavelengths allocation table, then the CO node switches on the new wavelength channel assigned to the control channel and starts transmission of the updated wavelengths allocation table using the new control channel

### 6) Modifying the Wavelengths Allocation:

In case the CO node changes partially or totally the wavelengths allocations to the ONUs, it switches off the downstream signal corresponding to each ONU impacted by the change and updates the wavelengths allocation table transmitted by the control channel. In parallel each ONU impacted by the wavelength re-allocation automatically recommence step 3) to obtain the updated wavelengths allocation table.

7) Support of Tunable ONUs with Different Ranges of Tunability

The selection of the control channel is performed considering the type of ONU connected and/or admitted in the network. The CO node selects the control channel corresponding to a wavelength that is in the wavelength tuning range of all the ONUs. In case there is one or more ONUs with no common wavelength, the CO node selects two or more control channels to ensure that a control channel signal reaches each of the ONUs.

FIG. 7 illustrates steps of an embodiment of a method 700 of configuring an ONU of a PON, the ONU comprising a tunable transmitter and a tunable receiver. The tunable transmitter is a tunable laser and the tunable receiver comprises a tunable filter and a receiver.

The method 700 starts and the ONU reads 702 its control channel register to obtain a default control channel wavelength and sets the tunable filter accordingly. The ONU checks 704 whether a LOS alarm is detected at its receiver. If yes, it selects a new channel wavelength to try as the control channel wavelength and writes 706 a new channel ID in the control channel register. If no, the ONU checks 708 a received downstream signal for a control channel identity. If the received downstream signal is identified as a control channel the ONU receives 710 a wavelengths allocation table on the control channel signal. If the received downstream signal is not identified as a control channel, the ONU selects a new channel wavelength to try as the control channel wavelength and writes 706 a new channel ID in the control channel register.

Following receipt of the wavelengths allocation table, the ONU identifies 712 its allocated channels and sets it tunable laser and it tunable receiver filter accordingly. The ONU checks 714 whether its allocated downstream channel is the same as the current control channel. If it is not, the ONU switches on 716 its transmitter and sends an ACK request to the CO node. If it is, the ONU checks 732 whether a LOS alarm is detected at its receiver. If there is no LOS alarm (i.e. a downstream signal is being received), the ONU returns to 702. If there is a LOS alarm (i.e. no downstream signal is being received), the ONU proceeds to switch on 716 its transmitter and send an ACK request to the CO node.

Once the ACK request has been sent, the ONU waits 718 and checks 720 if the ACK request is successful, i.e. has it received an ACK response from the CO node. If it is not successful, the ONU switches off 722 its transmitter and returns to 702. If it is successful, the ONU starts 726 traffic transmission and detection, continuing to check 728 for a LOS alarm. If a LOS alarm is detected at any time, the ONU switches off 722 its transmitter and returns to 702.

FIG. 9 illustrates steps of an embodiment of a method 900 of controlling operating wavelengths of an ONU of the PON.

The method starts with the CO node obtaining 902 a wavelengths allocation table and checking 904 the network status. The CO node checks 906 whether all PON channel wavelengths are in traffic mode. If they are not, the CO node identifies 908 and switches on OLTs allocates to one or more control channels and transmits 910 the wavelengths allocation table to the ONUs of the PON. The CO node then checks 912 whether new information about an ONU has been received from the network management system, NMS. If yes, the CO node checks 914 the information, updates the wavelengths allocation table accordingly, and transmits 910 the updated table. If no new information has been received from the NMS, the CO node checks 916 whether it has received a new ACK request from an ONU, the ACK request includes the ID of the ONU. If no, it waits 918 and checks again. If yes, the CO node cross-checks 920 that the wavelength that the ACK request was received on matches the wavelength in the wavelengths allocation table for that ONU ID and determines if 922 there is a match. If there is no match, the CO node proceeds to 918. If there is a match, the CO node checks 924 if the downstream channel allocated to that ONU ID is being used for a control channel. If it is not, the CO node switches on 928 its OLT for the allocated downstream wavelength and sends an ACK message to the ONU. If yes, the CO node first switches off 926 that control channel. The CO node then updates 930 the wavelengths allocation table.

If 906 all of the PON channel wavelengths are in traffic mode, the CO nodes determines 932 whether a reallocation of wavelength channels to ONUs is needed. If it is, the CO node switches off 936 its impacted OLT transceivers and updates 930 the wavelengths allocation table. If no wavelength reallocation is needed, the CO node checks 934 whether a LOS alarm is detected. If it is, the CO node proceeds to 936, and if not the CO node waits 938 and then proceeds to 904.

An embodiment provides a computer program 138 comprising instructions 136 which, when executed on at least one processor, cause the at least one processor to carry out steps of the method 600 of configuring an ONU of a PON.

An embodiment provides a computer program 328 comprising instructions 326 which, when executed on at least one processor, cause the at least one processor to carry out steps of the method 800 of controlling operating wavelengths of an ONU of the PON.

1. An optical network unit, ONU, for a passive optical network, PON, the ONU comprising:
a tunable receiver having a tunable operating wavelength;
a tunable transmitter having a tunable operating wavelength; and
a controller comprising at least one processor and memory containing instructions executable by the at least one processor whereby the ONU is operative to:
if the tunable transmitter is on, switch the tunable transmitter off and if the tunable receiver is off, switch the tunable receiver on;
determine a downstream control channel wavelength;
set an operating wavelength of the tunable receiver to the downstream control channel wavelength;
receive a downstream control channel signal at the downstream control channel wavelength from a central office, CO, node of the PON, the downstream control channel signal carrying an indication of an allocation of channel wavelengths to ONUs;
obtain allocated downstream and upstream channel wavelengths for the ONU from the indication of an allocation of channel wavelengths to ONUs;
set an operating wavelength of the tunable receiver to the allocated downstream channel wavelength and set the operating wavelength of the tunable transmitter to the allocated upstream channel wavelength; and
switch the tunable transmitter on.

2. An ONU as claimed in claim 1, wherein to determine a downstream control channel wavelength the ONU is operative to:
i. set the operating wavelength of the tunable receiver to a default downstream control channel wavelength;
ii. determine receipt or absence of a downstream channel signal at the set operating wavelength of the tunable receiver; and
iii. in response to determining receipt of a downstream channel signal at the set operating wavelength of the tunable receiver, determine that the received downstream channel signal includes a control channel identification and that the set operating wavelength of the tunable receiver is therefore the downstream control channel wavelength.

3. An ONU as claimed in claim 2, wherein the ONU is further operative to:
iv. in response to determining absence of a downstream channel signal at the set operating wavelength of the tunable receiver or that the received downstream channel signal does not include a control channel identification, set the operating wavelength of the tunable receiver to a different downstream channel wavelength of the PON and recommence at ii.

4. An ONU as claimed in claim 1, wherein the ONU is further operative to:
transmit an upstream signal at the allocated upstream channel wavelength to the CO node; and
in response to determining an acknowledgement is received from the CO node, commence transmitting upstream traffic signals at the allocated upstream channel wavelength.

5. An ONU as claimed in claim 4, wherein the ONU is further operative to:
in response to determining an acknowledgement is not received from the CO node, switch the transmitter off and recommence to determine a downstream control channel wavelength.

6. An ONU as claimed in claim 4, wherein the upstream signal includes an indication of an identification, ID, of the ONU.

7. An ONU as claimed in claim 1, wherein the ONU is further operative to:
in response to a loss of signal, LOS, alarm at the tunable receiver when the transmitter is switched on and transmitting upstream traffic signals at the allocated upstream channel wavelength, switch the transmitter off; and
recommence to determine a downstream control channel wavelength.

8. A central office, CO, node for a passive optical network, PON, the CO node comprising:
a plurality of optical line terminations, OLTs, operable at respective channel wavelengths of a PON, one of the OLTs being allocated to a control channel; and
a controller comprising at least one processor and memory containing instructions executable by the at least one processor whereby the CO node is operative to:
allocate the channel wavelengths to ONUs of the PON; and
transmit, on a downstream control channel signal from the allocated OLT at a downstream control channel wavelength, an indication of the allocation of channel wavelengths to ONUs of the PON.

9. A CO node as claimed in claim 8, wherein the CO node is operative to allocate channel wavelengths to ONUs until all the channel wavelengths except the control channel wavelengths have been allocated to ONUs and to then allocate the control channel wavelengths to an ONU.

10. A CO node as claimed in claim 9, wherein the CO node is operative to continuously transmit the indication of the channel wavelengths allocated to ONUs on the downstream control channel signal until all the channel wavelengths are allocated to ONUs.

11. A CO node as claimed in claim 8, wherein the CO node is further operative to:
receive identifications, IDs, of ONUs of the PON from a management system of the PON; and
wherein to allocate the channel wavelengths to ONUs the CO node is operative to allocate the channel wavelengths to the ONU IDs.

12. A CO node as claimed in claim 11, wherein the CO node is further operative to:
receive an upstream signal from an ONU on an upstream channel at an upstream channel wavelength, the upstream signal including an indication of an identification, ID, of the ONU; and
in response to determining that the upstream channel wavelength of the received upstream signal matches the upstream channel wavelength allocated to the ONU ID, send an acknowledgement to the ONU.

13. A CO node as claimed in claim 12, wherein the CO node is further operative to:
in response to determining that a channel wavelength of the upstream channel does not match the channel wavelength allocated to the ONU ID, not send an acknowledgement to the ONU.

14. A CO node as claimed in claim 8, wherein the CO node is further operative to:
i. change the allocation of channel wavelengths to ONUs of the PON; and
ii. stop transmitting downstream signals to ONUs having different allocated channel wavelengths as a result of the change.

15. A CO node as claimed in claim 11, wherein IDs of ONUs include tuning ranges of ONU tunable receivers and wherein the CO node is further operative to:
i. allocate to the control channel an OLT having a downstream wavelength falling within tuning ranges of the tunable receivers of the ONUs of the PON.

16. A CO node as claimed in claim 15, wherein the CO node is further operative to allocate to the control channel a first OLT having a first downstream wavelength falling within a tuning range of a first set of ONU tunable receivers and a second OLT having a second downstream wavelength falling within a tuning range of a second set of ONU tunable receivers, the second tuning range not overlapping with the first tuning range.

17. A CO node as claimed in claim 8, wherein the CO node is further operative to:
i. receive, from a management system of the PON, an indication that the downstream channel wavelength used for the downstream control channel is to be allocated to an ONU and an indication of a different channel wavelength to be used for the downstream control channel;
ii. stop transmitting the downstream control channel signal from the allocated OLT;
iii. update the allocation of channel wavelengths to ONUs of the PON;
iv. transmit, on a downstream control channel signal from an allocated OLT at the different downstream control channel wavelength, an indication of the updated allocation of channel wavelengths to ONUs of the PON.

18. A CO node as claimed in claim 8, wherein the downstream control channel signal includes a control channel identifier.

19. A passive optical network comprising:
a central office, CO, node for a passive optical network, PON, the CO node comprising:
a plurality of optical line terminations, OLTs, operable at respective channel wavelengths of a PON, one of the OLTs being allocated to a control channel; and
a controller comprising at least one processor and memory containing instructions executable by the at least one processor whereby the CO node is operative to:
allocate the channel wavelengths to ONUs of the PON; and
transmit, on a downstream control channel signal from the allocated OLT at a downstream control channel wavelength, an indication of the allocation of channel wavelengths to ONUs of the PON;
a plurality of optical network units, ONUs, as claimed in claim 1;
a wavelength agnostic distribution node connected to the CO by a feeder fibre and connected to the plurality of ONUs by a plurality of drop fibres.

20. The passive optical network of claim 19, further comprising:
a plurality of legacy optical line terminations, OLTs, at the CO;
a plurality of legacy ONUs;
a first coexistence filter coupling the OLTs and the legacy OLTs to the feeder fiber; and
at least one further coexistence filter coupling an ONU and a legacy ONU to the distribution node.

21. A method of configuring an optical network unit, ONU, of a passive optical network, PON, the ONU, comprising a tunable transmitter and a tunable receiver, the method comprising steps of:
if the tunable transmitter is on, switching the tunable transmitter off and if the tunable receiver is off, switching the tunable receiver on;
determining a downstream control channel wavelength;
setting an operating wavelength of the tunable receiver to the downstream control channel wavelength;
receiving a downstream control channel signal at the downstream control channel wavelength from a central office, CO, node of the PON, the downstream control channel signal carrying an indication of an allocation of channel wavelengths to ONUs;
obtaining allocated downstream and upstream channel wavelengths for the ONU from the indication of an allocation of channel wavelengths to ONUs;
setting an operating wavelength of the tunable receiver to the allocated downstream channel wavelength and setting the operating wavelength of the tunable transmitter to the allocated upstream channel wavelength; and
switching the tunable transmitter on.

22. A method at a central office, CO, node of a passive optical network, PON, of controlling operating wavelengths of an optical network unit, ONU, of the PON, the CO node comprising a plurality of optical line terminations, OLTs, operable at respective channel wavelengths of the PON, one of the OLTs being allocated to a control channel, the method comprising steps of:
i. allocating the channel wavelengths to ONUs of the PON; and
ii. transmitting, on a downstream control channel signal from the allocated OLT at a downstream control channel wavelength, an indication of the allocation of channel wavelengths to ONUs of the PON.

23. (canceled)
